(19) United States
(12) Patent Application Publication
(10) Pub. No.: US 2009/0319173 A1
(43) Pub. Date: Dec. 24, 2009

(54) METHOD AND APPARATUS FOR PRESENTING NAVIGATION INFORMATION

(75) Inventor: Preston R. McAfee, San Marino, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/145,447

(22) Filed: Jun. 24, 2008

(51) Int. Cl. G01C 21/34

(52) U.S. Cl. 701/201

(57) ABSTRACT

A method and device which may present more user-friendly navigation information. A user may be on a trip to a destination, following a route calculated by a navigation device. When the user stops and searches for a place he is interested in with the navigation device, the destination, the route and the user's moving direction may be considered when presenting a list of search results. The navigation device may search a database to obtain search results matching the user's searching criteria. For each search result, the navigation device may determine a branch route connecting the search result and the current geographic location. Search results requiring considerable back-tracking may be ignored, and the remaining search results may be presented to the user.

### BACKGROUND

1. Field of the Invention

The present invention relates generally to personal navigation devices, and more particularly to a method and apparatus for presenting user-friendly navigation information.

2. Description of Related Art

Personal navigation devices receive navigation signals wirelessly and provide guidance to users, either in a car or on foot, using the Global Positioning System (GPS). In addition to providing directions and calculating travel routes, personal navigation devices may have search functions, helping a user to find a place he is interested in, e.g., a restaurant, a gas station, a hospital or a post office. For example, a user may be traveling from his home in a city A to a hotel H in a city B, and his navigation device has calculated the fastest route from his home to the hotel H and displayed a map on the screen of his navigation device, with the fastest route highlighted. The user may follow the highlighted route. Before arriving at the city B, the user may want to have lunch and may use his navigation device to find a restaurant close to his current geographic location.

Currently available navigation devices usually display a list of restaurants on the screen, according to their distances from the user's current geographic location. The user may decide which restaurant he wants to go to based on its name and the distance. However, some of the restaurants on the list may be between the user's current geographic location and the city A and require back-tracking. Since the user needs to select a search result in the list to figure out where it is, he may have to spend time sifting through many useless results. In addition, a user's favorite restaurant may be buried within the useless results, and the user may miss it, or may have to scroll through several pages before getting to it.

Therefore, it may be desirable to provide a method and apparatus which may help to search for a place a user is interested in while filtering out search results that are useless to the user.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates a navigation system which may be used with the present invention.

FIG. 2 illustrates a block diagram of a personal navigation device which may incorporate the present invention.

FIG. 3 is a flow chart of a method of presenting navigation information according to one embodiment of the present invention.

FIG. 4 is a flow chart of a method of presenting navigation information according to one embodiment of the present invention.

### DETAILED DESCRIPTION

The present invention provides a method and device which may present more user-friendly navigation information. A user may be on a trip to a destination, following a route calculated by a navigation device. When the user stops en route to the destination and searches for a place he is interested in with the navigation device, the destination, the route and the user's moving direction may be considered when presenting a list of search results. The navigation device may search a database to obtain search results matching the user's searching criteria. For each search result, the navigation device may determine a branch route connecting the search result and the current geographic location. Search results requiring considerable back-tracking may be ignored, and the remaining search results may be presented to the user. The invention may be carried out by computer-executable instructions, such as program modules. Advantages of the present invention will become apparent from the following detailed description.

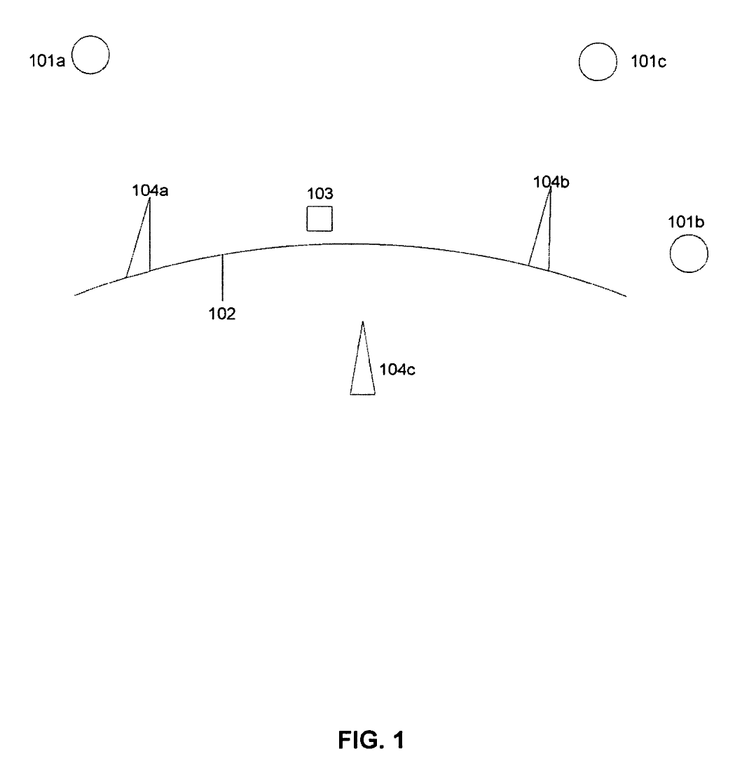

FIG. 1 illustrates a navigation system which may be used with the present invention. The navigation system may be, e.g., a Global Positioning System (GPS). As shown, a number of satellites, e.g., 101a, 101b, and 101c, may orbit the earth 102 and broadcast navigation signals. A navigation device 103 may receive navigation signals from the satellites directly, or via base stations on earth, e.g., 104a, 104b and 104c.

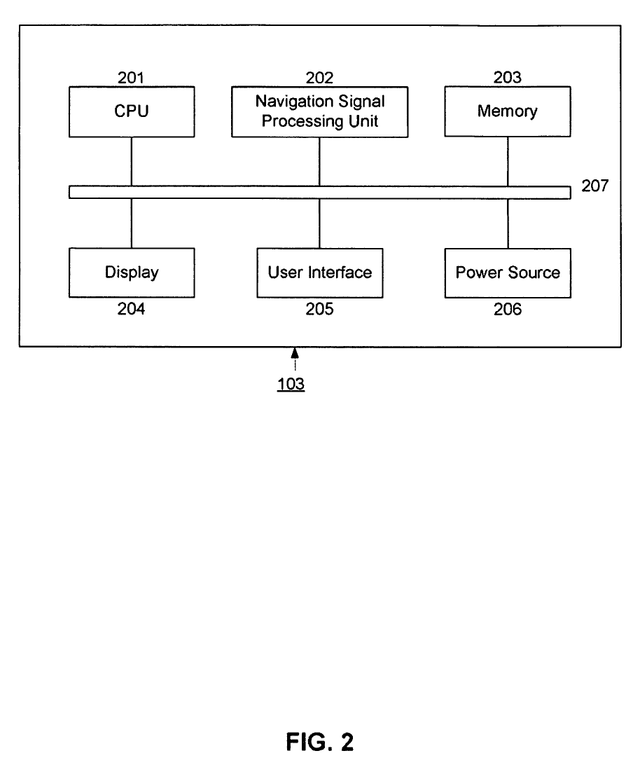

FIG. 2 illustrates a block diagram of a personal navigation device which may incorporate the present invention. The navigation device 103 may be any electronic device operable to receive and utilize navigation signals. The navigation device 103 may be a handheld navigation device, an automobile navigation device, a computer or PDA running navigation software, or a mobile phone or a portable entertainment device running navigation software. The navigation device 103 may have a CPU 201, a navigation signal processing unit 202, a memory 203, a display 204, a user interface 205, and a power source 206. These elements may be coupled to each other via wired or wireless connections, e.g., a bus 207, to exchange data and signals.

In one embodiment, the navigation signal processing unit 202 may receive navigation signals from satellites and determine the current geographic location of the navigation device, which is also the current geographic location of the user. In one embodiment, the navigation signal processing unit 202 may receive navigation signals from three different satellites, e.g., 101a-101c, and determine the current geographic location by performing, e.g., triangulation calculations. The navigation signal processing unit 202 may then forward the location information to the CPU 201 to enable it to, e.g., provide directions from the current geographic location to a destination, or search a place of interest close to the current geographic location.

In one embodiment, instead of receiving the navigation signals from the satellites, the navigation signal processing unit 202 may receive navigation signals from base stations, e.g., 104a-104c.

In one embodiment, instead of processing the navigation signals and determining the current geographic location, the navigation signal processing unit 202 may receive the navigation signals and forward them to the CPU 201, and the CPU 201 may use these data to calculate the current geographic location of the navigation device 103.

In one embodiment, the navigation signal processing unit may be software running on CPU 201. A radio or other wireless device or module within navigation device 103 may receive signals from satellites 101a-101c or earth stations 104a-104c, and the software may process the signals.

The memory 203 may be a removable memory device (e.g., a DVD) or a non-removable memory device (e.g., a RAM or ROM). The memory 203 may store a map of a certain geographic area including, e.g., street names, addresses, points of interest, names of businesses, and geographic entities. The memory 203 may also store a user's recent routes and destinations.

The memory 203 may further store a directory of elements of the map, and a user may search the data stored in the memory 203. The directory may have several levels. When a user selects an option to search for a place, a first level including Place Name and Place Type may be displayed. If the user wants to search for a specific place, e.g., Starbucks or McDonald's, he may select “Place Name” and then input the place name via the user interface 205. If the user wants to search for a type of place, e.g., a restaurant, he may select “Place Type” and a second level including a number of types of places may be displayed. The types of places may be, e.g., Attractions, Businesses, Financial Services, Gas, Hospitals and Restaurants. If the user selects “Restaurants,” a third level including a number of types of restaurants may be displayed. The third level may include, e.g., Bars, Burgers, Chinese, Coffee, French, Italian, or Mexican.

The user interface 205 may comprise buttons, a touch screen, a microphone, or a speaker used to communicate with a user. A user may input his commands or selections via the buttons, the touch screen or the microphone. In one embodiment, the user may use a knob to move a cursor on the display 204 to an option, and then press an Enter button to select it. In one embodiment, available options may be shown on the display 204, and the user may press on an option to select it. In one embodiment, the user may input his commands via the microphone.

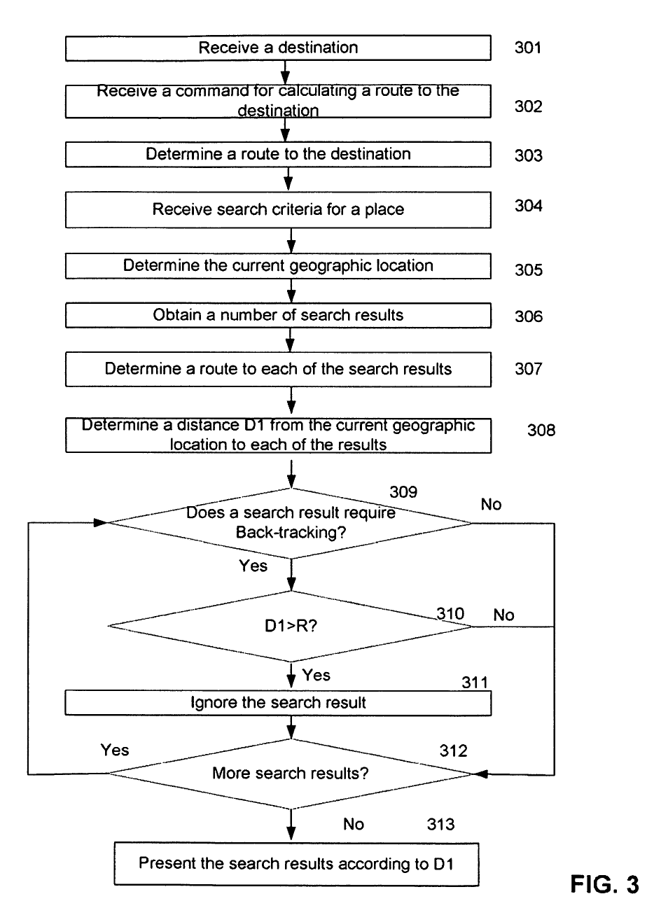

The CPU 201 may control various processes of the navigation device 103, including but not limited to the process shown in FIG. 3.

The CPU 201 may receive navigation signals from the navigation signal processing unit 202 and determine the current geographic location of the navigation device 103. The CPU 201 may then use the current geographic location to calculate a route to a destination or to search a place of interest close to the current geographic location. In one embodiment, the CPU 201 may receive the current geographic location from the navigation signal processing unit 202.

The CPU 201 may receive map data from the memory 203, and control the display 204 to show a map, e.g., around the user's current geographic location. The CPU 201 may search the map data for a place a user is interested in.

The CPU 202 may receive a user's commands via the user interface 205.

FIG. 3 is a flow chart of a method of presenting navigation information according to one embodiment of the present invention. The method may be used with the navigation system shown in FIG. 1, and in the navigation device shown in FIG. 2.

At 301, a destination may be received, e.g., via the user interface 205.

At 302, a command for calculating a route to the destination may be received. A user may select to calculate a fastest route to the destination, or a shortest route to the destination, or a route that does not use freeways, etc.

At 303, a route to the destination may be calculated by the CPU 201, stored in the memory 203 and shown on the display 204, so that the user can follow it to drive to the destination.

At 304, search criteria for a place and a search command may be received. For example, the search criteria may be an Italian restaurant nearby.

At 305, the current geographic location of the navigation device 103 may be determined. In one embodiment, the navigation signal processing unit 202 may receive navigation signals, determine the current geographic location and send it to the CPU 201. In one embodiment, the navigation signal processing unit 202 may receive navigation signals and forward them to the CPU 201 so that the CPU 201 may determine the current geographic location. The navigation signal processing unit 202 may receive the navigation signals from satellites 101a-101c or base stations 104a-104c.

At 306, the CPU 201 may search the memory 203 to obtain a number of Italian restaurants around the current geographic location.

At 307, the CPU 201 may determine a branch route, which is a route from the current geographic location to each of the restaurants.

At 308, the CPU 201 may calculate a driving distance D1 from the current geographic location to each of the restaurants.

At 309, the CPU 201 may determine whether a restaurant is behind the current geographic location and thus requires back-tracking. The CPU 201 may use the map data in the memory 203 to make the decision. If not, the process may proceed to 312.

If a destination restaurant requires back-tracking, at 310, the CPU 201 may compare the driving distance D1 to the restaurant with a value R preset by the user. In one embodiment, R may be 5 miles. If the user does not want to tolerate any back-tracking, he may set R as a small value, e.g., 0 mile. If D1 does not exceed R, the process may proceed to 312.

If D1 exceeds R, then the restaurant may be ignored at 311. When the preset value R is 5 miles, each restaurant which requires back-tracking and has a more than a 5 mile driving distance D1 may be ignored. When R is 0 mile, all restaurants requiring back-tracking may be ignored.

At 312, the CPU 201 may determine whether there are more search results. If yes, the processing may return to 309. Otherwise, at 313, the remaining restaurants may be presented on the display 204 as a list, with their names and driving distance D1 shown, starting from the one with the shortest driving distance D1.

In one embodiment, restaurants requiring back-tracking may be marked.

Since restaurants requiring considerable back-tracking are ignored, such restaurants may not appear on the list and may not interfere with the user's selection of restaurant.

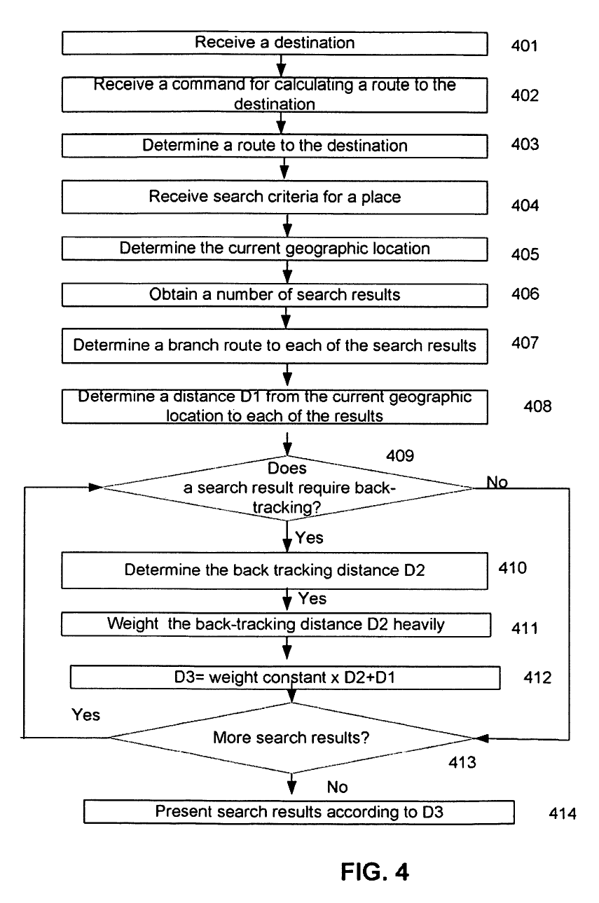

FIG. 4 is a flow chart of a method of presenting navigation information according to one embodiment of the present invention. The method may be used with the navigation system shown in FIG. 1, and in the navigation device shown in FIG. 2. 401-408 may be similar to 301 to 308 shown in FIG. 3.

At 409, the CPU 201 may determine whether a restaurant is behind the current geographic location and thus requires back-tracking. The CPU 201 may use the map data in the memory 203 to make the decision. If not, the process may proceed to 413.

If a restaurant requires back-tracking, at 410, the CPU 201 may calculate a back-tracking distance D2 of the restaurant. The back-tracking distance D2 may be the distance between the restaurant and the current geographic location along the direction of the route.

At 411, the CPU 201 may weight the back-tracking distance heavily. The user may select a weight constant. If the user does not want to tolerate any back-tracking, he may choose a high weight constant, e.g., 100.

At 412, a weighted distance D3 between the current geographic location and the restaurant may be calculated as: weight constant×D2+D1.

At 413, the CPU 201 may determine whether there are more search results. If yes, the process may return to 409.

Otherwise, at 414, the CPU 201 may control the display 204 to present a list of restaurants according to the weighted distances D3, with the restaurant having the shortest weighted distance D3 being presented first. Since the driving distances for restaurants requiring back-tracking are heavily weighted, such restaurants may be shown later in the list and may not interfere with the user's selection of a restaurant.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of presenting search results on a navigation device, the method comprising:
receiving a destination;
determining a route from an origin to the destination;
receiving search criteria for a place;
determining a current geographic location of the navigation device which is between the origin and the destination;
searching a memory device for places matching the criteria; and
presenting a list of search results, taking into consideration the relationship between a search result and the route from the origin to the destination.

2. The method of claim 1, further comprising: determining a branch route from the current geographic location to each of the search results.

3. The method of claim 2, further comprising: determining whether a search result requires back-tracking.

4. The method of claim 3, further comprising: reducing the number of search results requiring back-tracking.

5. The method of claim 4, further comprising: determining the length of a branch route.

6. The method of claim 5, further comprising: determining whether the length of the branch route is longer than a predetermined value.

7. The method of claim 6, further comprising: ignoring the search result when it requires back-tracking and its branch route exceeds the predetermined value.

8. The method of claim 7, further comprising: indicating that the search result requires back-tracking when presenting the list of search results.

9. The method of claim 3, further comprising: ignoring a search result when it requires back-tracking.

10. The method of claim 5, further comprising: determining a back-tracking distance of a search result, wherein the back-tracking distance is a distance between the search result and the current geographic location along the direction of the route.

11. The method of claim 10, further comprising: weighting the back-tracking distance with a weight constant.

12. The method of claim 11, further comprising: obtaining a weighted branch route distance by adding the weighted back-tracking distance to a length of the branch route.

13. The method of claim 12, further comprising: presenting the search results according to the weighted branch route distance.

14. A computer program product comprising a computer-readable medium having instructions which, when performed by a computer, perform a method for presenting search results on a navigation device, the method comprising:
receiving a destination;
determining a route from an origin to the destination;
receiving search criteria for a place;
determining a current geographic location of the navigation device which is between the origin and the destination;
searching a memory device for places matching the criteria; and
presenting a list of search results, taking into consideration the relationship between a search result and the route from the origin to the destination.

15. The computer program product of claim 14, wherein the method further comprises: determining whether a search result requires back-tracking.

16. The computer program product of claim 15, wherein the method further comprises: determining a branch route from the current geographic location to a search result and a length of the branch route.

17. The computer program product of claim 16, wherein the method further comprises: indicating that a search result requiring back-tracking when presenting the list of the search results.

18. The computer program product of claim 15, wherein the method further comprises: determining a back-tracking distance of a search result, wherein the back-tracking distance is a distance between the search result and the current geographic location along the direction of the route.

19. The computer program product of claim 18, wherein the method further comprises: weighting the back-tracking distance with a weight constant, and reducing the number of search results requiring back-tracking using the weighted back-tracking distance.

20. A personal navigation device, comprising:
a navigation information processing unit for receiving navigation signals from a navigation system;
a memory for storing a map;
a display for displaying the map;
a user interface for receiving commands; and
a CPU which:
receiving a destination;
determining a route from an origin to the destination;
receiving search criteria for a place;
determining a current geographic location of the navigation device which is between the origin and the destination;
searching a memory device for places matching the criteria; and
presenting a list of search results, taking into consideration the relationship between a search result and the route from the origin to the destination.
